(19) United States
(12) Patent Application Publication
(10) Pub. No.: US 2026/0105053 A1
(43) Pub. Date: Apr. 16, 2026

(54) AUTOMATED DATA FABRIC ORCHESTRATION

(71) Applicant: INTERNATIONAL BUSINESS MACHINES CORPORATION, Armonk, NY (US)

(72) Inventors: Balakumaran VAITHYALINGAM, Frisco, TX (US); Latha NAGANNA, Bangalore (IN); Sudhakar T. SESHAGIRI, Bangalore (IN); Abhishek SETH, Deoband (IN); Soma Shekar NAGANNA, Bangalore (IN)

(21) Appl. No.: 18/914,934

(22) Filed: Oct. 14, 2024

(51) Int. Cl. G06F 16/2455; G06F 16/2453

(52) U.S. Cl. CPC G06F 16/2456; G06F 16/24535

(57) ABSTRACT

Computer implemented methods, systems, and computer program products include program code executing on a processor(s) that ingests metadata from heterogenous data sources and applications that have data relationships in a distributed computing system. Based on the ingested metadata, the program code determines data asset join conditions between data comprising the heterogeneous data sources. The program code automatically persists the data asset join conditions as executable objects in a data catalog of the distributed data architecture.

### BACKGROUND

The present invention relates generally to the field of data management, and in particular, to a method for automated persistence of data connections as executable virtual catalog objects (EVCO) to automatically retrieve information from heterogenous data across relational database systems based on integrating domain knowledge into data catalog systems.

Big data refers to extremely large and diverse collections of structured, unstructured, and semi-structured data that continue to grow exponentially over time. Big data refers to datasets that are so huge and complex in volume, velocity, and variety, that traditional data management systems cannot store, process, and analyze them. Volume, velocity and variety are referred to as the “Three Vs” of big data. Two additional Vs, variability and value, have been proposed for use as a descriptor for these sets as well. Variability refers to an increase in the range of values typical of a large data set while value addresses the need for valuation of enterprise data.

A data catalog is a detailed inventory of data assets in an organization, designed to help data professionals quickly find the most appropriate data for any analytical or business purpose. To that end, a data catalog uses metadata, data that describes or summarizes data, to create an informative and searchable inventory of all data assets in an organization. Although there are various classes of metadata, data catalogs primarily utilize three types: technical metadata, process metadata, and business metadata, collectively referred to as governance artifacts.

Governance artifacts, technical metadata, process metadata, and business metadata, encompass items including, but not limited to, policies, rules, data protection rules, business glossary terms, data classes, and classifications. These artifacts can be created by data stewards (or business users) and can be auto linked with data assets through an automated data catalog, enabling the program code comprising the database manager to effectively and efficiently manage, maintain, protect, visualize, and report upon (e.g., for audits and/or compliance) data housed in the database.

Ontology is a set of concepts and categories in a subject area or domain that illustrates their properties and the relationships between them. A role of ontologies with respect to database systems is to specify a data modeling representation at a level of abstraction above specific database designs (e.g., logical or physical), so that data can be exported, translated, queried, and unified across independently developed systems and services.

A data fabric is a conceptual representation or architecture of how data assets can be organized and delivered to the consuming systems or data consumers. A data fabric is an architecture that facilitates end-to-end integration of various data pipelines and cloud environments using intelligent and/or automated systems.

In structured query language (SQL), a programming language for storing and processing information in a relational database, JOIN (referred to herein as a JOIN statement) is a command clause that combines records from two or more tables in a database. Specifically, a JOIN combines data in fields from two tables by using values common to each table. In a query, JOIN clause is considered complex because simple queries retrieve data from a single table while a JOIN retrieves data from multiple tables. There are four different types of JOINs: inner JOIN, left outer JOIN, right outer JOIN, and full outer JOIN. An inner JOIN combines two tables based on a shared key (i.e., each table has a column called “userid”). A left JOIN returns all rows from the first table and only the rows in the second table that match. A right JOIN returns all rows the second table, and only the rows in the first table that match. A full outer JOIN combines the left and right joins to return all rows from both tables provided there is at least one match.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided through the provision of a computer-implemented method for generating executable objects to publish virtualized views. The method can include ingesting, by one or more processors, metadata from heterogenous data sources in a distributed computing system; based on the ingested metadata, determining, by the one or more processors, data asset join conditions between data comprising the heterogeneous data sources; and automatically persisting, by the one or more processors, the data asset join conditions as objects in a data catalog of the distributed data architecture.

Shortcomings of the prior art are overcome, and additional advantages are provided through the provision of a computer program product for generating executable objects to publish virtualized views. The computer program product comprises a storage medium readable by a one or more processors and storing instructions for execution by the one or more processors for performing a method. The method includes, for instance: ingesting, by the one or more processors, metadata from heterogenous data sources in a distributed computing system; based on the ingested metadata, determining, by the one or more processors, data asset join conditions between data comprising the heterogeneous data sources; and automatically persisting, by the one or more processors, the data asset join conditions as objects in a data catalog of the distributed data architecture.

Shortcomings of the prior art are overcome, and additional advantages are provided through the provision of a system for generating executable objects to publish virtualized views. The system includes: a memory, one or more processors in communication with the memory, and program instructions executable by the one or more processors via the memory to perform a method. The method includes, ingesting, by the one or more processors, metadata from heterogenous data sources in a distributed computing system; based on the ingested metadata, determining, by the one or more processors, data asset join conditions between data comprising the heterogeneous data sources; and automatically persisting, by the one or more processors, the data asset join conditions as objects in a data catalog of the distributed data architecture.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an illustration of a current data architecture that does not include aspects of the examples herein;

FIG. 3 is an illustration of a data architecture that includes various aspects of the present disclosure;

FIG. 4 is a workflow that provides an overview of various aspects performed by the program code (executing on one or more processors) in some embodiments of the present disclosure;

FIG. 5 is a workflow that provides an overview of various aspects performed by the program code (executing on one or more processors) in some embodiments of the present disclosure;

FIG. 6 is a workflow that provides an overview of various aspects performed by the program code (executing on one or more processors) in some embodiments of the present disclosure; and

FIG. 7 is an illustration of data layers utilized in the examples herein to generate executable database objects.

### DETAILED DESCRIPTION

Developments within hybrid cloud, artificial intelligence (AI), the internet of things (IoT), and edge computing have led to the exponential growth of big data, creating even more complexity for enterprises to manage. Data diversity and volume have made the unification and governance of data environments an increasing priority as this growth has created significant challenges, such as data silos, security risks, and general bottlenecks to decision making. Data fabric solutions address these challenges by leveraging new development to unify their disparate data systems, embed governance, strengthen security and privacy measures, and provide more data accessibility to workers, including but not limited to, business users.

The examples herein include computer-implemented methods, computer systems, and computer program products, where program code executing on one or more processors ingests data comprising asset relationships from various sources using various processes, including but not limited to database transaction logs, logical data models, physical data models, extract, transform, and load (ETL) job metadata (e.g., ETL is a process of combining data from multiple sources into a repository), and/or stored procedures. In some examples, upon ingesting these data, the program code persists these data asset join conditions in a data catalog (e.g., in an executable fashion). Persisting data refers to storing data on a non-volatile medium. The program code can rank join conditions based on pre-defined factors. The program code automatically extrapolates each join in the data catalog using a multi-layered approach to leverage the relationships between governance artifacts and data assets as well as relationships within governance artifacts. The program code automatically reconfigures the data catalog with virtualized joins (e.g., AutoSQL) for re-execution with a multi-layer query capability. AutoSQL is a non-limiting example of a universal query engine that can be utilized in the examples herein and is provided for illustrative purposes only and not to introduce any limitations.

AutoSQL is a universal query engine which can be understood as a distributed query engine for a data landscape. Data queries can be located in different (hybrid) locations, including but not limited to internal and external (to an organization) data warehouses, in object storage, on one or more cloud computing resources, etc. In more traditional relational database query engine architecture, program code moves data to a database engine, which executes queries. The AutoSQL query engine instead pushes queries down to a source, enabling the engine to access diverse sets of data, including, but not limited to, databases, data lakes, and/or streaming data.

The examples herein are inextricably tied to computing and are directed to a practice application. Database management and query engines are both inextricably tied to computing and the program code in the examples herein is directed to the practical application of executing automated data orchestration, which enables more effective and accurate query execution across hybrid data sources. In the examples herein, program code executing on one or more processors automatically discovers relationships for a data fabric (e.g., a conceptual representation or architecture of how data assets can be organized and assembled automatically). While traditional approaches have limitations to relationship discovery which limits discover relationships between multiple database objects, but instead are limited within each given database, the examples herein not only enable relationship discovery across multiple databases but also capture these relationships and couple this data capture with a method to execute automated data orchestration.

The computer-implemented methods, computer systems, and computer program products described herein provide significantly more than existing database management techniques including by efficiently providing accurate business-ready data to end users. The examples herein increase query efficiency and efficacy by automatically joining assets across different data repositories to deliver these business-ready data to end users, which the end users can utilize for, among other things, deriving business insights. Presently, providing data accounting for the relationships that the program code and the examples herein automatically implement can only be accomplished manually and cannot be accomplished fully or efficiently based on the manual intervention. Present database management approaches do not enable program code to assemble data through a multi-dimensional approach based on artifacts, including but not limited to business terms, data classes, tags, and/or other business label, and technical data assets (e.g., tables and files). This multi-dimensional approach, which is integrated into the examples herein, is not available in existing approaches because in these existing approaches, complex relationships are available only at table level. The examples herein automatically extrapolate each join in the data catalog using a multi-layered approach, which accounts for artifacts and technical assets, to leverage the relationships between governance artifacts and the data assets as well as relationships within governance artifacts. Unlike in existing approaches, the examples herein integrate domain knowledge (ontologies) with relational database management system (RDBMS) structured query language (SQL) queries to provide more precise query results than existing approached (which utilize imprecise semantic queries).

The computer-implemented methods, computer systems, and computer program products described herein provide also significantly more than existing database management techniques by utilizing various approaches that improve query efficiency as well as results. For example, the program code in the examples herein automatically orchestrates a data fabric by determining relationships between assets without utilizing a data model. Introducing a data model would include the use of complex data mapping as well as complex data loading procedures, both of which are avoided here. Additionally, the use of virtual objects, which will be explained in greater detail herein, for master data management (MDM) systems with critical data elements (CDEs) maintains data privacy by eliminating data copies, complex data integration (e.g., inbound) processes while providing a 360-degree view by orchestrating data from both CDEs (e.g., MDM) and non-CDEs (e.g., virtual objects connected to multiple data sources). Data privacy is simplified in the examples herein at least because metadata management and data lineage reporting for regulatory compliance is simplified because a majority of the data resides solely in the source system (the program code in the examples herein does not make any copies). Persistence of CDEs helps to perform data stewardship, suspect duplicate processing (SDP), and manage suspect entries, including for regulatory purposes. In the examples herein, as opposed to existing approaches, complex data cleansing process as part of data integration is not needed for data integrity at least because the examples herein can includes a semantic label-based SDP technique that enables program code to uncover buried and/or misplaced information and align these data in relevant buckets for the SDP. The model-less design described herein supports MDM techniques, including but not limited to analytical MDM and operational MDM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

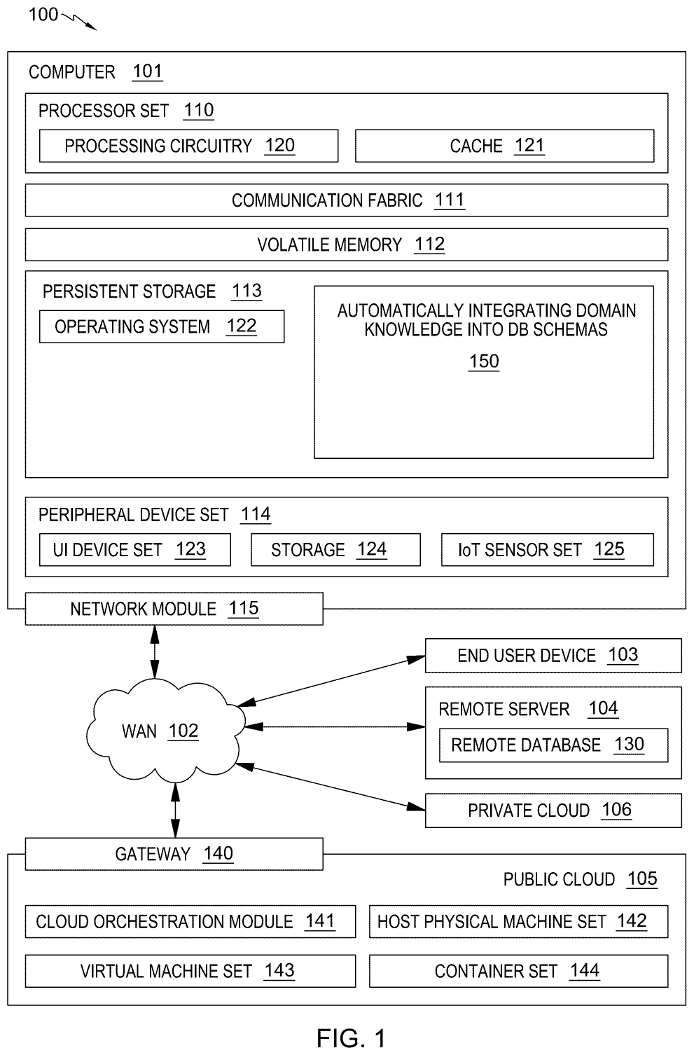

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for automatically integrating domain knowledge into data catalog systems 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Using a data fabric can address various challenges in environments where decisions are driven by data, including but not limited to, data integration, data governance, data observability, data catalog, data orchestration, and MDM. Utilizing a data fabric enables access to disparate data storage repositories. Generally, a data fabric can include various components or features, one such component is an augmented knowledge graph which provides a common business understanding of the data processing and automation to act on insights. A data fabric enables intelligent integration meaning that various integration styles can be utilizes within this architecture (e.g., program code can extract, ingest, stream, virtualize, and/or transform unstructured data), to maximize performance while minimizing storage and costs. The data fabric supports self-service consumption, letting users find, collaborate and access high-quality data. Additionally, the data fabric enables a unified data lifecycle, including end-to-end lifecycle management for composing, building, testing, optimization, and/or deploying the data fabric architecture. Data fabrics can also provide multimodal governance by enabling unified definition and enforcement of data policies, data governance, data security and data stewardship for a business-ready data pipeline. Finally, as in this example, data fabrics are an architecture element (e.g., of an AI-infused composable architecture) that can be implemented in a hybrid environment, including but not limited to hybrid environments, including but not limited to hybrid cloud computed environments as well as other distributed environments.

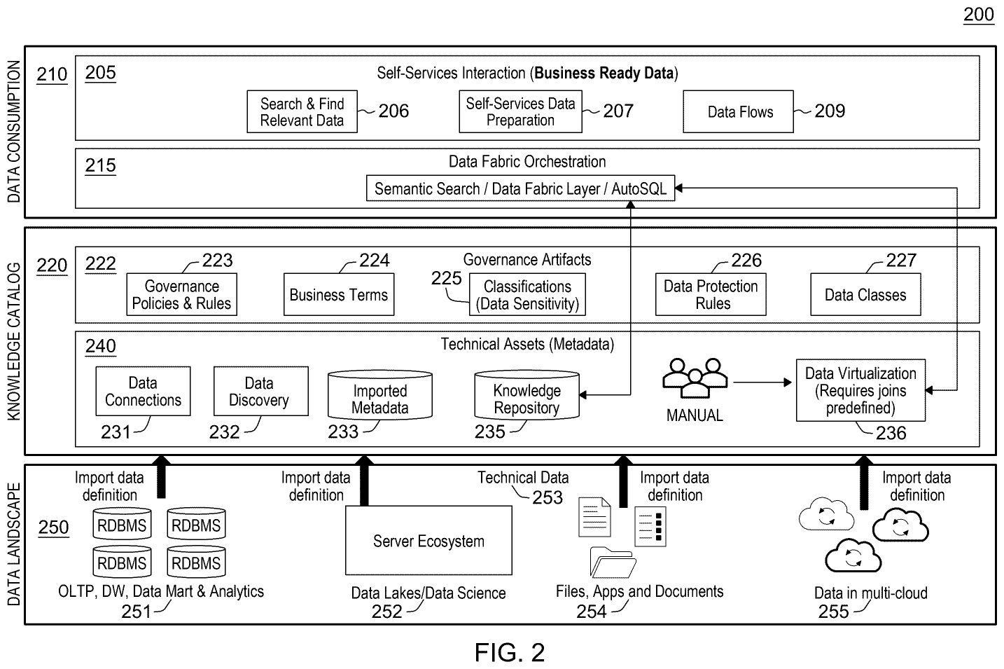

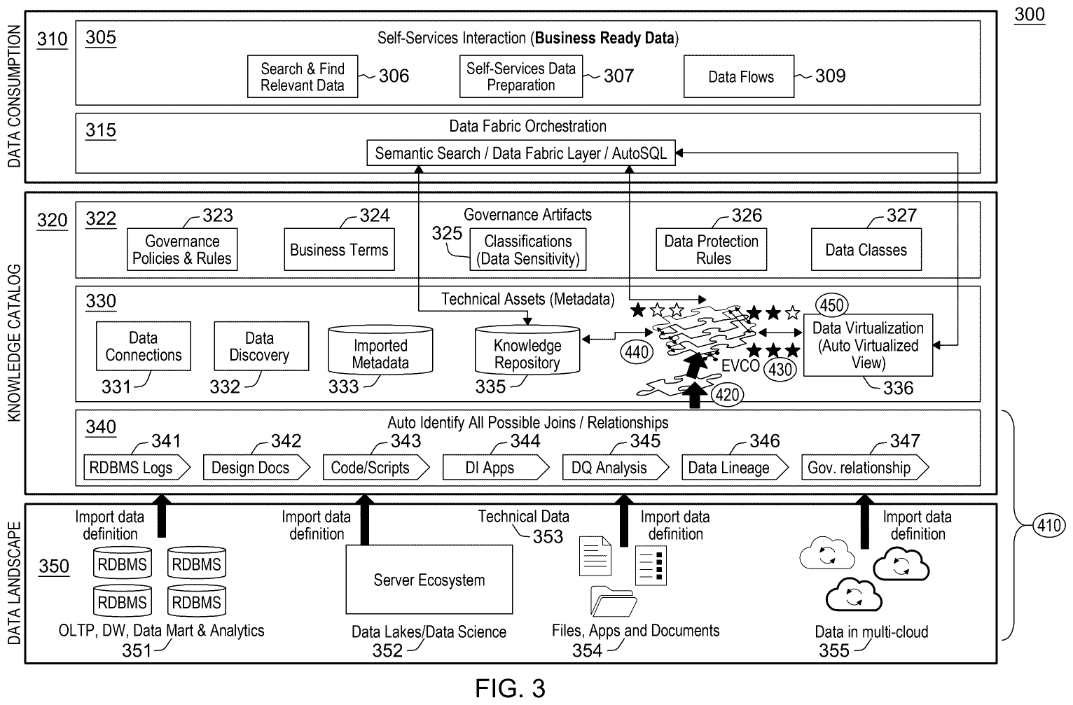

FIGS. 2 and 3 illustrate database architectures. FIG. 2 is a current database architecture 200 that does not include the implementation of the examples described herein. FIG. 3 is a database architecture 300 that in which program code executing on one or more processors generates and implements an executable virtualized catalog object. The executable virtualized catalog object includes relationships between various data sources in the hybrid data environment of the architecture. These relationships are manually implemented, if at all, in the current database architecture 200. Thus, certain relationships are not recognized. The program code in the examples herein not only automatically identifies these relationships but also memorializes these relationships in an executable virtualized catalog object that can be accessed when querying resources of the architecture. As will be described in greater details herein, in the database architecture 300 herein, in contrast to the current database architecture 200, the program code engaged in data fabric orchestration 315 enables a data fabric to automatically generate data virtualization 326 elements as technical assets (metadata) 330 in a knowledge catalog 320 of the database architecture 300.

FIG. 2 is a current database architecture 200 that does not include the implementation of the examples described herein. As illustrated in this architecture 200, any joins or relationships between different data sources are manually user-defined (e.g., see, data virtualization 226). In contrast, in the examples herein, relationships and possible joins are automatically defined utilizing the data fabric. However, the current database architecture 200 provides an illustration to contextualize the examples herein. The current database architecture 200 includes various layers: a data consumption layer 210, a knowledge catalog 220, and a data landscape 250. The data consumption layer 210 enables a user to interact with underlying data. As such, it includes business ready data 205 and program code that performs data fabric orchestration 215. Both the business ready data 205 and the data fabric orchestration 215 enable data consumption. The business ready data 205, which can be understood as self-service interaction data, includes interfaces that enable users to search and find relevant data 206, provide users with self-services data preparation 207, and provide data flows 209. The program code performing data fabric orchestration 215 manages and implements functionality, including but not limited to, semantic searches, the data fabric layer, and a query engine (e.g., AutoSQL). AutoSQL is provided as a non-limiting examples of a query engine that can be implemented in various data architectures and is provided for illustrative purposes only and not to suggest any limitations. As illustrated in FIG. 2, the program code performing data fabric orchestration 215 accesses a knowledge repository 235 (e.g., comprising metadata), in the knowledge catalog 220 to update the metadata.

The knowledge catalog 220 layer in the current database architecture 200 includes governance artifacts 222. Governance artifacts can be used in the current database architecture 200 to provide enrichment (e.g., add knowledge and meaning to assets), control access (e.g., control who sees what data or which artifacts), identification (e.g., provide criteria to identify assets or data for other artifacts), and/or quality control (e.g., monitor data quality). The examples of governance artifacts 222 in the current database architecture 200 include governance policies and ruled 223, business terms 224, classifications 225 (e.g., based on data sensitivity), data protection rules 226, and data classes 227.

The knowledge catalog 220 layer in the current database architecture 200 also includes a metadata layer, referred to as technical assets 230. The technical assets 230 include metadata from data connections 231, data discovery 232, imported metadata 233, the knowledge repository 235 (which is accessed by the program code that performs data fabric orchestration 215), and data virtualization 236, which in the current database architecture 200 as any joins or relationships between different data sources are manually user-defined. Because of the manual nature of the data virtualization 226 aspect, any join across data sources is manually defined and hence, various connections are not defined. The data virtualization 226 imports data definition from data in a distributed environment and in this example, in a multiple cloud environment 255.

The data landscape 250 of the current database architecture 200 is a source of metadata for the technical assets 230 of the knowledge catalog 220. The data landscape 250 includes technical data 253 from various data sources, including analytics from RDBMS (relational database management system software), such as online transaction processing (OLTP), data warehouse (DW), and/or data mart, analytics 251, data lakes and/or data science 252 (from which definition can be imported), files, applications, and/or documents 254, (which can be imported for data definition), and data assets in a multiple cloud environment 255 (which can be imported for data definition). Hence, the current database architecture 200 and specifically, the data fabric aspect of this architecture does not include automated data discovery and/or automated relationship discovery.

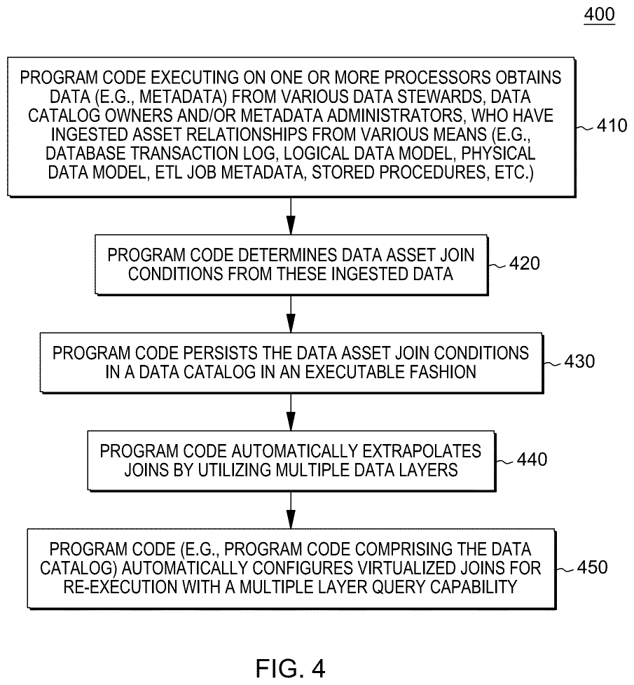

FIG. 3 illustrates a database architecture 300 where the program code implements an executable virtualized catalog object (EVCO). Certain elements of the database architecture 300 are similar to those in the current database architecture 200. In FIG. 3, database architecture 300 into which various aspects of the examples here can be implemented various layers: a data consumption layer 310, a knowledge catalog 320, and a data landscape 350. As with FIG. 3, the data consumption layer 310 enables a user to interact with underlying data. As such, it includes business ready data 305 and program code that performs data fabric orchestration 315. Both the business ready data 305 and the data fabric orchestration 315 enable data consumption. The business ready data 305, which can be understood as self-service interaction data, includes interfaces that enable users to search and find relevant data 306, provide users with self-services data preparation 307, and provide data flows 309. The program code performing data fabric orchestration 315 manages and implements functionality, including but not limited to, semantic searches, the data fabric layer, and a query engine (e.g., AutoSQL). AutoSQL is provided as a non-limiting example of a query engine that can be implemented in various data architectures and is provided for illustrative purposes only and not to suggest any limitations. As also illustrated in FIG. 2, in FIG. 3, the program code performing data fabric orchestration 315 accesses a knowledge repository 335 (e.g., comprising metadata), in the knowledge catalog 320 to update the metadata. However, in this database architecture 300, the program code performing data fabric orchestration 315, and specifically the data fabric, performs a process 400 (which is also illustrated in the workflow 400 of FIG. 4 and in FIG. 3 includes aspects 410, 420, 430, 440, and 350), to generate and implement an executable virtualized catalog object in a data virtualization 326 element. The aspects of the workflow 400 to generate and implement this object are labeled in FIG. 3 but provided in more detail as FIG. 4.

In FIG. 3, the knowledge catalog 320 layer includes governance artifacts 322. The examples of governance artifacts 322 in the database architecture 300 include governance policies and rules 323, business terms 324, classifications 325 (e.g., based on data sensitivity), data protection rules 326, and data classes 327.

As aforementioned, there are differences in the knowledge catalog 220 320 layers between the current data architecture 200 and the data architecture 300 as aspects of the examples herein have been implemented in the data architecture 300 of FIG. 3. Referring to FIG. 3, the knowledge catalog 320 layer in the database architecture 300 includes a metadata layer, referred to as technical assets 330. The technical assets 330 include metadata from data connections 331, data discovery 332, imported metadata 333, the knowledge repository 335 (which is accessed by the program code that performs data fabric orchestration 315), and data virtualization 336, which includes an automatically generated virtualized view. The program code performs the workflow 400 described in FIG. 4 (and illustrated as well in FIG. 3), to generate this view. At the completion of the description of the database architecture 300 of FIG. 3, this

[symbol]

Referring to FIG. 4 and the program code performing data fabric orchestration 315 and accessing and updating the knowledge catalog 320 in FIG. 3. As illustrated with common labels in FIGS. 3-4 for clarity, program code executing on one or more processors obtains data (e.g., metadata) from various data stewards, data catalog owners and/or metadata administrators, who have ingested asset relationships from various means (e.g., database transaction log, Logical data model, physical data model, ETL job metadata, stored procedures, etc.) (410). The program code determines data asset join conditions from these ingested data (420) and persists these data asset join conditions in a data catalog in an executable fashion (430). As illustrated in FIG. 3, program code executing as part of a knowledge catalog 320 automatically identifies various joins in relationships in the ingested data 340, which includes, RDBMS logs 341, design documents 342, code and scripts 343, data insight (DI) applications 344, data quality (DQ) analysis 345, data lineage 346, and governance relationships 347. In the data architecture 300, the additional layer in which the program code identifies the relationships 340 is layered over the data landscape 350 layer.

Returning to the workflow 400, in some examples, the program code can rank different join conditions when more than one join condition is relevant to a common asset. In some examples, when there is more than one join condition for the same two data assets, it ranks the join condition based on various factors: 1) type of source; 2) whether the join is user-defined; 3) whether the join is result of an ensemble algorithm; and 4) whether there is a user override based on confidence score and/or rank. Regarding the first factor, type of source refers to a type of source from where the join relationship is interpreted by the catalog. Previous executed joins (such as a RDBMS transaction logs or ETL jobs) would be ranked higher while join conditions derived by the program code from design metadata (e.g., logical data models or physical data models) would be ranked lower. Regarding the second factor, the program code can assign higher ranks to joins manually created by users. Regarding the third factor, ensemble algorithms, depending upon the re-execution of joins from the data catalog, program code executing on one or more processors can increase a confidence score and/or rank based on reinforcement learning being applied to permutations and combinations with a policy gradient function being applied to modify the ranking. However, the fourth factor can impact confidence scores and/or ranks as well because as a user can override a score based on domain knowledge.

Once the program code has persisted the data and ranks joins, the program code can automatically extrapolate joins by utilizing multiple data layers (440). These layers can include, but are not limited to, business terms, data classes, tags, and/or other business labels. In these examples, the data assets leverage the relationships between governance artifacts 320 and data assets as well as relationships within governance artifacts 320. The program code (e.g., program code comprising the data catalog) automatically configures virtualized joins (e.g., AutoSQL) for re-execution with a multiple layer query capability (450). Because the program code extrapolated the joins and/or relationships at the various levels (e.g., business term, data class, tags, and/or other business labels), the program code can uncover and enable this new type of relationship.

As in the current data architecture 200, in the data architecture 300 of FIG. 3, the data landscape 350 is a source of metadata for the technical assets 330 of the knowledge catalog 320. The data landscape 350 includes ) technical data 353 from various data sources, including analytics from RDBMS, such as online transaction processing (OLTP), data warehouse (DW), and/or data mart, analytics 351, data lakes and/or data science 352 (from which definition can be imported), files, applications, and/or documents 354, (which can be imported for data definition), and data assets in a multiple cloud environment 355 (which can be imported for data definition). The data fabric of the database architecture 300 and specifically, the data fabric includes automated data discovery and/or automated relationship discovery.

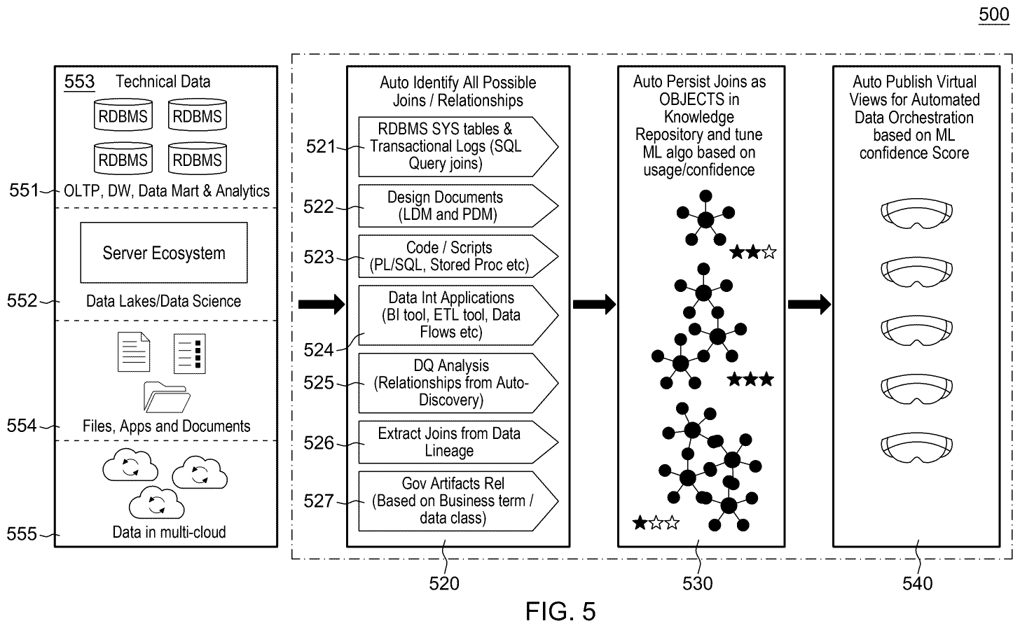

FIG. 5 provides additional detail to illuminate the workflow 400 of FIG. 4 further, in the context of the database architecture 300 of FIG. 3. FIG. 5 illustrates a data ingested (e.g., from a data landscape 350 (e.g., FIG. 3) by program code in some examples herein, including technical data 553, which can include OLTP, DW, data mart, and data analytics 551, data lakes and/or data science 552, files, applications, and documents 554, and/or data in a multiple cloud environment 555. These sources are provided as examples of different components of a hybrid distributed data environment into which aspects of the example herein can be implemented. Program code executed on one or more processors automatically identifies possible joins and/or relationships in these ingested data (520). The program code can identify various aspects in the sources well as commonalities between sources. For example, the program code can identify SQL query joins based on RDBMS system tables and transactional logs (521). The program code can identify relationships based on logical data models (LDMs) and physical data models (PDMs) in design documents (523). The program code can identify joins based on scripts and code, such as procedural language and/or SQL, stored procedures, etc. (524). The program code can also identify these relationships based on data intelligence applications, including business intelligence tools, extract transfer, and load (ETL) tools, data flows, etc. (525). The program code can determine relationships or joins based on performing data quality analyses based on the automatically discovered relationships (526). The program code, in identifying these relationships or joins, can also extract data from a data lineage (527). The program code can infer the joins and relationships based on government artifact relationships, based on business terms and/or data classifications (528). The program code automatically persists these joins as objects in the knowledge repository and tunes a machine learning algorithm based on usage and confidence (530). The ranking of various joins discussed in FIG. 4 is part of this tuning process. The program code can assign levels of confidence to various relationships and based on results provided and acceptance or rejection of these results, the program code can tune a machine learning algorithm to revise confidence levels, for example, such that certain relationships and joins rank above others and depending on thresholds, some may not be included in the knowledge repository. The program code can automatically publish virtual views for automated data orchestration based on confidence scores (540) (e.g., FIGS. 3, 350, FIGS. 4, 450). These published views are executable virtualized catalog objects (EVCO).

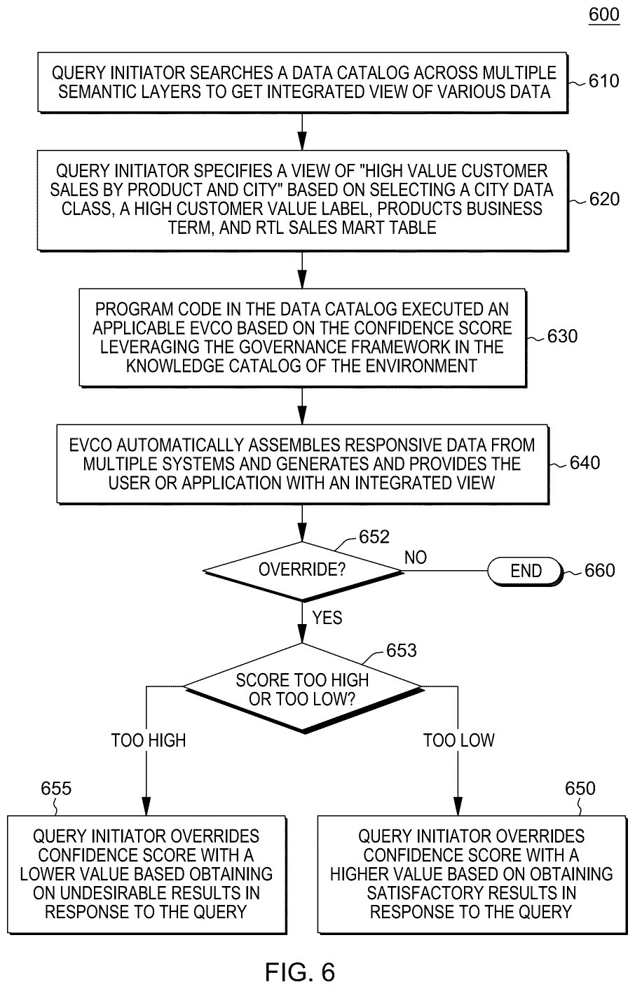

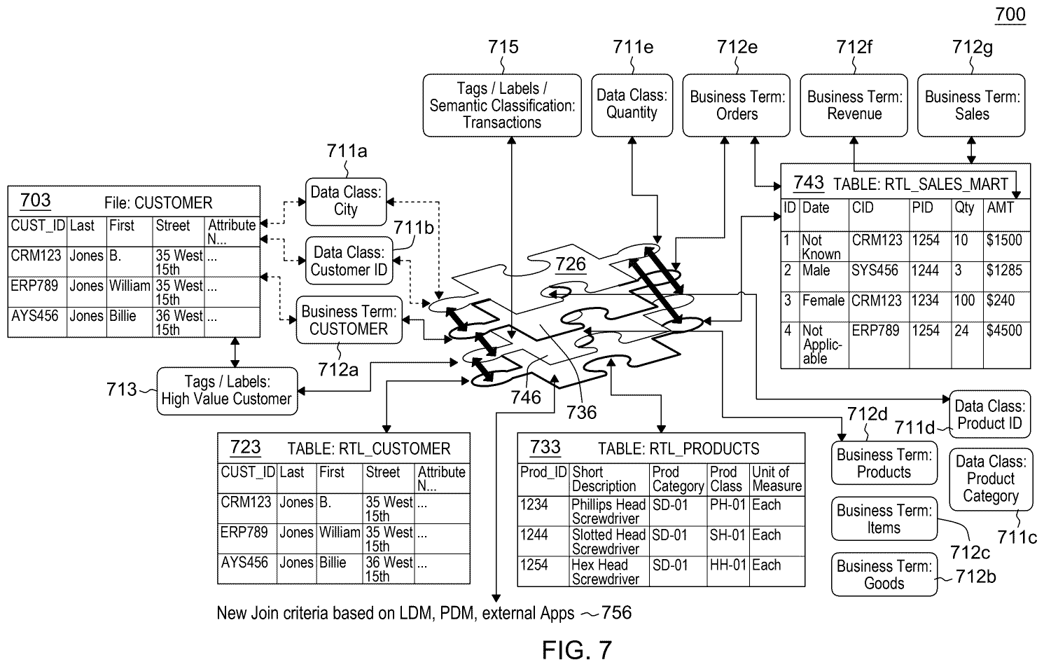

FIG. 6 is a workflow 600 that provides a non-limiting example of how a user can utilize an EVCO that was automatically implemented utilizing the processes described in FIGS. 3-5. Specificity in FIG. 6 is not provided to suggest any limitations but rather to demonstrate the utility of the examples herein in a given context. As illustrated in FIG. 6, a user, who can be a business user without technical skills, or an application (e.g., an API) searches a data catalog across multiple semantic layers to get integrated view of various date (610). The user can be understood as a query initiator. In this example, the user or application is requesting a view of customer, product, and sales data from multiple systems. The user and/or application does not know of underlying database object structures or relationships between the systems from which these data are sought. Based on the search, the user specifies a view of “high value customer sales by product and city” based on selecting a CITY data class, a HIGH CUSTOMER VALUE label, PRODUCTS business term, and RTL_SALES_MART table (620). The user can specify this ontology at different levels. Program code in the data catalog executed an applicable EVCO based on the confidence score leveraging the governance framework in the knowledge catalog of the environment (630). Based on being executed by the program code (or otherwise triggered), the applicable EVCO automatically assembles responsive data from multiple systems and generates and provides the user or application with an integrated view (640). For example, the program code can assign CITY data class and HIGH VALUE CUSTOMER label to a CUSTOMER file in a Hadoop system, a PRODUCTS business term to RTL_PRODUCTS in a Db2 system, and the RTL_SALES_MART table in an AWS redshift. These example databases are provided for illustrative purposes only as various databases and data sources can be utilized in the examples herein. The EVCO automatically orchestrates the data and delivers the integrated view to the user and/or application. As illustrated in FIG. 6, a business user or application could override (652) the applicable EVCO confidence score with a lower value (653) if the user or application received undesirable results in response to the query (655). The user or application could override (652) the EVCO confidence score to a higher value (653) if the user or application received satisfactory results through EVCO (650). If a user does not override (652) the score, the score will remain the same as was computed by the program code (660). The program code can utilize these scores to train the machine learning algorithms that identify the relationships that are used to generate the EVCO and hence, the revise the EVCO. In this multiple later approach, the program code can automatically identify connections between different layers of data: classes (e.g., city, customer identifier, quantity, product identifier, and product category), business terms (e.g., customer, products, orders, revenue, items, sales), tags, labels, and semantic classifications (e.g., high value customer, transactions), and new join criteria (e.g., based on LDM, PDM, and external applications). The multiple layers join to form a conceptual view. FIG. 7 provides an illustration of the various layers.

FIG. 7 illustrates an environment 700 that includes tables from more than one relational database and a data file and illustrated the multiple layers: data class, business term, tags, and new joins, which combine to enable the program code to generate EVCOs, assets that include these relationships and are executable views that can be utilized by end users. The file 703 is a customer file and includes the fields: customer identifier, last name, first name, street, and an attribute file (e.g., high value customer). Tables in the environment include a retail customer table 723, a retail products table 733, and a retail sales market table 743. Each data source (the file and the tables) include data classes 711a-711e, business terms 712a-712g, and can include tags or labels 713. Tags, labels, and semantic classifications 715 can be generated by joining various data from the sources. The program code generate a new join based on LDM, PDM, and external applications 756. The layers on the join generated utilizing all the layers include data class 726, business term 736, tags, labels, and where available, semantic classifications 746.

As illustrated herein, the program code in the examples herein generates EVCOs which can be understood as resident is an asset repository which captures information access pattern utilized for the existing schema where the metadata has been imported into a data catalog. The EVCO repository contains information that is accessed at a log level of a database and any optimizations that were applied to these data (e.g., logs, statistics for executed queries, frequent queries, joins, stored procedure etc.). The program code can utilize design documents when generating EVCO assets. The program code assembles and identifies connection in data from hybrid sources (e.g., heterogenous databases and hybrid cloud applications) by leveraging governance frameworks to create and extrapolate multiple layer ontology. In some examples, the program code capture relationships between data through a combination of the available information and using the generative AI capabilities which is backed by a semantic search and the classification of the data. As such, the program code can orchestrate joins in data from multiple systems without knowing underlying database object joins and/or relationships and without upfront manual configuration from users as the EVCO objects can be executed to generate views that show these relationships.

The examples herein include computer-implemented methods, computer program products, and computer systems for generating executable objects to publish virtualized views. In some examples, program code executing on one or more processors ingests metadata from heterogenous data sources and applications that have data relationships in a distributed computing system. Based on the ingested metadata, the program code determines data asset join conditions between data comprising the heterogeneous data sources. The program code automatically persists the data asset join conditions as executable objects in a data catalog of the distributed data architecture.

In some examples, the program code executes the objects to generate virtualized views for automated data orchestration.

In some examples, the program code obtains a query from an application executing on one or more resources of the distributed computing system. The program code identifies an object of the objects, where the identified object is relevant to the query. The program code executes the identified object. Based on the executing, the program code automatically publishes an object of the objects to generate a virtualized view responsive to the query.

In some examples, the program code determining the data asset join conditions further comprises: the program code leveraging relationships between governance artifacts and data assets and relationships within governance artifacts.

In some examples, the objects comprise virtualized joins for re-execution with a multiple layer query capability.

In some examples, the program code determining the data asset join conditions comprises: the program code extrapolating the data asset join conditions by utilizing multiple data layers.

In some examples, the multiple data layers are selected from the group consisting of: business terms, data classes, tags, and other business labels.

In some examples, the heterogenous data sources are selected from the group consisting of: database transaction logs, logical data models, physical data models, ETL job metadata, and stored procedures.

In some examples, the program code determining the data asset join conditions further comprises: the program code identifying, in the data asset join conditions, more than one condition relevant to a common asset, and the program code ranking the more than one conditions. The persisting can utilize the ranking.

In some examples, the ranking for each join condition is based on factors selected from the group consisting of: type of data source, whether the join condition is user-defined, whether the join condition is a result of an ensemble algorithm, and whether the join condition was affected by a user override based on rank.

In some examples, the program code obtains feedback on the virtualized view responsive to the query. The program code adjusts a confidence score of at least one asset join condition based on the feedback. The program code utilizes the adjusted confidence score of the at least one asset to train a machine learning algorithm.

In some examples, the program code determining further comprises the program code applying the trained machine learning algorithm.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A computer-implemented method for generating executable objects to publish virtualized views, comprising:
ingesting, by one or more processors, metadata from heterogenous data sources and applications that have data relationships in a distributed computing system;
based on the ingested metadata, determining, by the one or more processors, data asset join conditions between data comprising the heterogeneous data sources, the join conditions comprising join relationships in the ingested metadata;
automatically persisting, by the one or more processors, the data asset join conditions as executable objects in a data catalog of the distributed data architecture, wherein the data catalog comprises layers and wherein the layers comprise a data landscape layer and a relationship layer comprising the join relationships; and
executing, by the one or more processors, the executable objects, to generate virtualized views for automated data orchestration.

2. (canceled)

3. The computer-implemented method of claim 1, wherein executing the executable objects further comprises:
obtaining, by the one or more processors, a query from an application executing on one or more resources of the distributed computing system;
identifying, by the one or more processors, an executable object of the executable objects, wherein the identified object is relevant to the query;
executing, by the one or more processors, the identified object; and
based on the executing the identified object, automatically publishing, by the one or more processors, an executable object of the executable objects to generate a virtualized view of the virtualized views for automated data orchestration responsive to the query.

4. The computer-implemented method of claim 1, wherein determining the data asset join conditions further comprises:
leveraging, by the one or more processors, relationships between governance artifacts and data assets and relationships within governance artifacts.

5. The computer-implemented method of claim 1, wherein the executable objects comprise virtualized joins for re-execution with a multiple layer query capability.

6. The computer-implemented method of claim 1, wherein determining the data asset join conditions comprises:
extrapolating, by the one or more processors, the data asset join conditions by utilizing multiple data layers.

7. The computer-implemented method of claim 6, wherein the multiple data layers are selected from the group consisting of: business terms, data classes, tags, and other business labels.

8. The computer-implemented method of claim 1, wherein the heterogenous data sources are selected from the group consisting of: database transaction logs, logical data models, physical data models, ETL job metadata, and stored procedures.

9. The computer-implemented method of claim 1, wherein determining the data asset join conditions further comprises:
identifying, by the one or more processors, in the data asset join conditions, more than one condition relevant to a common asset; and
ranking, by the one or more processors, the more than one conditions, wherein the persisting utilizes the ranking.

10. The computer-implemented method of claim 9, where the ranking for each join condition is based on factors selected from the group consisting of: type of data source, whether the join condition is user-defined, whether the join condition is a result of an ensemble algorithm, and whether the join condition was affected by a user override based on rank.

11. The computer-implemented method of claim 3, further comprising:
obtaining, by the one or more processors, feedback on the virtualized view responsive to the query;
adjusting a confidence score of at least one asset join condition based on the feedback; and
utilizing, by the one or more processors, the adjusted confidence score of the at least one asset to train a machine learning algorithm.

12. The computer-implemented method of claim 11, wherein the determining further comprises applying the trained machine learning algorithm.

13. A computer system for generating executable objects to publish virtualized views, comprising:
a memory; and
one or more processors in communication with the memory, wherein the computer system is configured to perform a method, said method comprising:
ingesting, by the one or more processors, metadata from heterogenous data sources and applications that have data relationships in a distributed computing system;
based on the ingested metadata, determining, by the one or more processors, data asset join conditions between data comprising the heterogeneous data sources, the join conditions comprising join relationships in the ingested metadata; and
automatically persisting, by the one or more processors, the data asset join conditions as executable objects in a data catalog of the distributed data architecture, wherein the data catalog comprises layers and wherein the layers comprise a data landscape layer and a relationship layer comprising the join relationships; and
executing, by the one or more processors, the executable objects, to generate virtualized views for automated data orchestration.

14. (canceled)

15. The computer system of claim 13, the method further comprising
obtaining, by the one or more processors, a query from an application executing on one or more resources of the distributed computing system;
identifying, by the one or more processors, an executable object of the executable objects, wherein the identified object is relevant to the query;
executing, by the one or more processors, the identified object; and
based on the executing, automatically publishing, by the one or more processors, an executable object of the executable objects to generate a virtualized view responsive to the query.

16. The computer system of claim 13, wherein determining the data asset join conditions further comprises:
leveraging, by the one or more processors, relationships between governance artifacts and data assets and relationships within governance artifacts.

17. The computer system of claim 13, wherein the executable objects comprise virtualized joins for re-execution with a multiple layer query capability.

18. The computer system of claim 13, wherein determining the data asset join conditions comprises:
extrapolating, by the one or more processors, the data asset join conditions by utilizing multiple data layers.

19. The computer system of claim 18, wherein the multiple data layers are selected from the group consisting of: business terms, data classes, tags, and other business labels.

20. A computer program product for generating executable objects to publish virtualized views, the computer system comprising:
one or more computer readable storage media and program instructions collectively stored on the one or more computer readable storage media readable by at least one processing circuit to:
ingest metadata from heterogenous data sources in a distributed computing system;
based on the ingested metadata, determine data asset join conditions between data comprising the heterogeneous data sources, the join conditions comprising join relationships in the ingested metadata; and
automatically persist the data asset join conditions as executable objects in a data catalog of the distributed data architecture, wherein the data catalog comprises layers and wherein the layers comprise a data landscape layer and a relationship layer comprising the join relationships; and
execute the executable objects, to generate virtualized views for automated data orchestration.
